(19) United States
(12) Patent Application Publication
(10) Pub. No.: US 2007/0119037 A1
(43) Pub. Date: May 31, 2007

(54) Process for manufacturing armrests

(75) Inventors: Rod Anderson, Burlington (CA); Ezio Berardelli, Richmond Hill (CA)

Correspondence Address: LANG MICHENER, BCE PLACE, P.O. BOX 747, SUITE 2500, 181 BAY STREET, TORONTO, ON, M5J 2T7, CA

(73) Assignee: Progressive Moulded Products Limited

(21) Appl. No.: 11/367,316

(22) Filed: Mar. 6, 2006

(30) Foreign Application Priority Data
Nov. 28, 2005 (CA) 2,528,305

(51) Int. Cl. B68G 7/00

(52) U.S. Cl. 29/91; 29/91.1

(57) ABSTRACT

According to an aspect of the present invention, there is provided a process for manufacturing armrests with soft covers, comprising the steps of: a) providing a soft cover, b) providing a substrate, the substrate divided into two substrate parts, and c) attaching the cover to the substrate to form an armrest by engaging each of the two substrate parts with opposite ends of the cover and manipulating the two substrate parts such that the two substrate parts engage each other to form a unitary substrate securely covered by the cover.

### FIELD OF THE INVENTION

The present invention relates to the field of manufacturing components for automobiles. In particular, it relates to an improved process for manufacturing partially deformable or soft-topped armrests.

### BACKGROUND OF THE INVENTION

Soft-topped console armrests for automobiles can be manufactured and assembled in several different ways. In one method, the final assembly takes place by taking a manufactured armrest “skin” or soft cover (e.g. injection moulded PVC) and then stretching or otherwise engaging it over the solid substrate (typically plastic) of the armrest and adding a secondary cover or closeout. The armrest is then secured to the console, possibly with additional elements such as a hinge and latching mechanism to allow access to a storage compartment located within the console under the armrest.

The difficulty with the existing assembly process is that stretching the cover over the substrate requires deformation of the cover. Once stretched, the substrate may not securely engage the cover as the cover lacks full recovery from the deformation process. This can result in a loosely fitting cover that may bulge, sag or, even worse, one that comes off the substrate some time after the assembly process is complete and the automobile has reached the consumer. It is thus desirable to develop an assembly process that does not require deformation of the soft cover.

One method of making an armrest is disclosed in U. S. Pat. No. 5,738,810 issued to De Filippo which describes a method of manufacturing headrests and armrests by creating a pillow element covered by an upholstery sheet. The upholstery sheet extends beyond the perimeter of the pillow such that when the pillow is placed into a mould the sheet extends into the mould. The mould is then filled with foamed plastic material to form an outer body for the pillow and simultaneously secure the pillow and sheet to the body.

Another method is disclosed in U.S. Pat. No. 5,628,545 issued to Perthius et al. which describes a method of covering a cushion for a vehicle seat by using a non-stretch cord contained within a pleated margin of the cover. The non-stretch cord then holds the margin against the bottom of the cushion to assist in holding the cover in place.

Still another method is disclosed in U. S. Pat. No. 5,098,622 issued to Lilienthal et al. which describes a method of making an armrest. The armrest is formed from a two-piece structural insert which is used to first injection mould an outer vinyl skin around the first insert and then couple the second insert to the first. The whole is then placed in a foam mould and the body is created between the structure and the vinyl skin using urethane foam.

Based on the prior art, there is a need for a new method of assembling armrests that allows for the assembly combination of a cover and a solid structure without requiring deformation of the cover.

### SUMMARY OF THE INVENTION

According to an aspect of the present invention, there is provided a process for manufacturing armrests with soft covers, comprising the steps of: a) providing a soft cover, b) providing a substrate, the substrate divided into two substrate parts, and c) attaching the cover to the substrate to form an armrest by engaging each of the two substrate parts with opposite ends of the cover and manipulating the two substrate parts such that the two substrate parts engage each other to form a unitary substrate securely covered by the cover. Ideally, the two substrate parts are identical, near identical, or mirror images of one another.

Preferably, the unitary substrate is then secured to a base. Additionally, a hinge and clasp can be added and opposite ends of the cover or closeout prior to attaching the cover to the substrate.

Preferably, the substrate parts have flanges that interlock to form the unitary substrate. These flanges may be severable after assembly of the unitary substrate.

According to another aspect of the invention, an armrest with a soft cover is provided as formed according to the methods described above.

An advantage of the present invention is that the soft cover of the armrest is not deformed during assembly, thereby allowing it to retain its shape and remain securely engage to the substrate.

Other and further advantages and features of the invention will be apparent to those skilled in the art from the following detailed description thereof, taken in conjunction with the accompanying drawings.

### BRIEF DESCRIPTION OF THE DRAWINGS

The invention will now be described in more detail, by way of example only, with reference to the accompanying drawings, in which like numbers refer to like elements, wherein:

FIG. 1 is a perspective view of an armrest embodying the features of the present invention along with a floor console for an automobile;

FIG. 2 is exploded view of the armrest of FIG. 1;

FIG. 3 is a side view of the initial step in the process of assembling the armrest of FIG. 1;

FIG. 4 is a side view of an intermediate step in the process of assembling the armrest of FIG. 1; and

FIG. 5 is a side view of the final step in the process of assembling the armrest of FIG. 1.

### DETAILED DESCRIPTION OF THE PREFERRED EMBODIMENTS

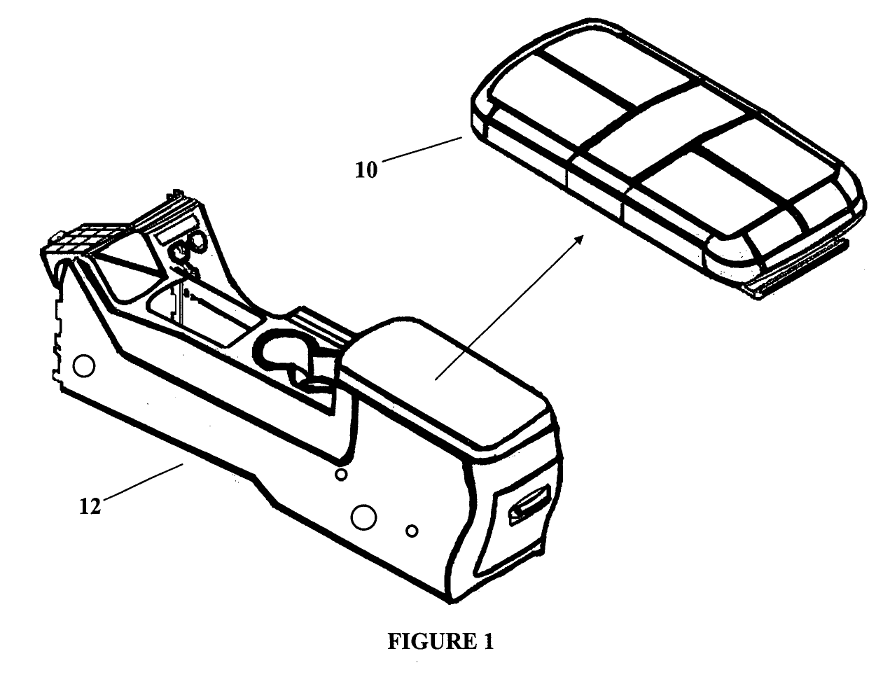

Referring now to FIG. 1, the soft armrest in accordance with a presently preferred embodiment of the invention is indicated generally at 10. Soft armrest 10 is designed to be incorporated into a floor console 12 for an automobile (not shown). The soft armrest is positioned such that a driver or passenger in the automobile can rest their arm on the soft armrest 10 in comfort. Additionally, the area in the floor console 12 underneath the soft armrest 10 may be used for storage, necessitating that the soft armrest 10 have a hinge and latching mechanism to provide access to storage while ensuring that soft armrest 10 remains in position while the vehicle is in motion or in the event of an accident.

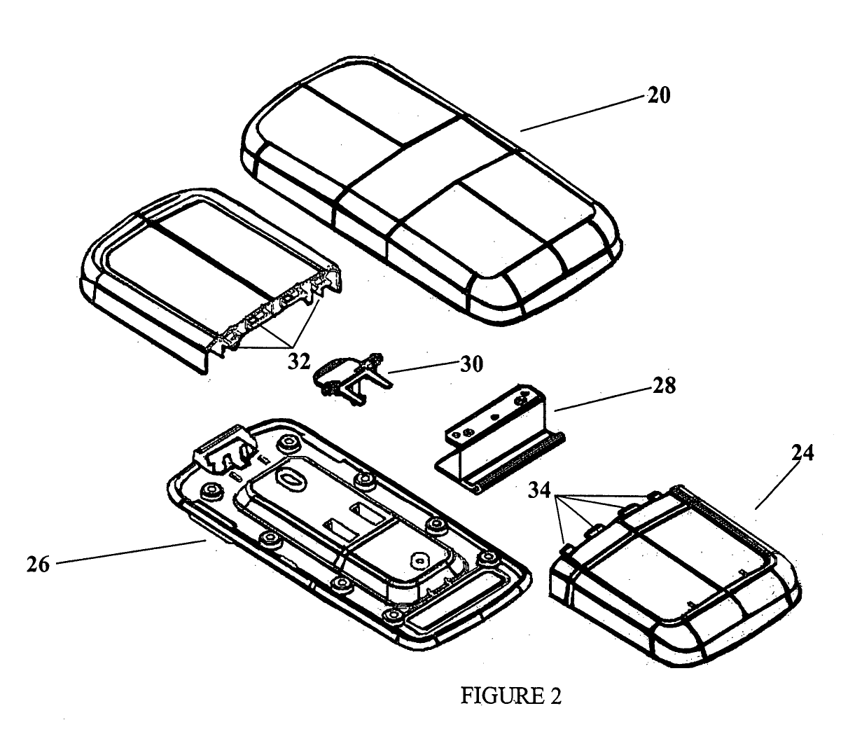

FIG. 2 shows an exploded view of the various components of soft armrest 10 according to the preferred embodiment for installation over a console storage space. The top consists of a soft cover 20, which fits over a first substrate element 22 and a second substrate element 24. The substrate elements 22 and 24 are designed to be secured to a base 26. Additional components include a hinge 28 and a clasp 30 that allow the soft armrest 10 to be lifted to access a storage compartment inside the floor console 12 (as shown in FIG. 1). The hinge 28 and clasp 30 are secured between the substrate elements 22 and 24 and the base 26. The hinge 28 and clasp 30 can be of various types known in the art.

First substrate element 22 and second substrate element 24 are formed with interlocking flanges or “fingers” 32 and 34, respectively. Fingers 32 and 34 interlock such that substrate elements 22 and 24 can be locked together into a single substrate element. For ease of manufacture, and if assembly conditions permit, it is preferable to design the substrate elements 22 and 24 with fingers 32 and 34 such that first substrate element 22 and second substrate element 24 are identical.

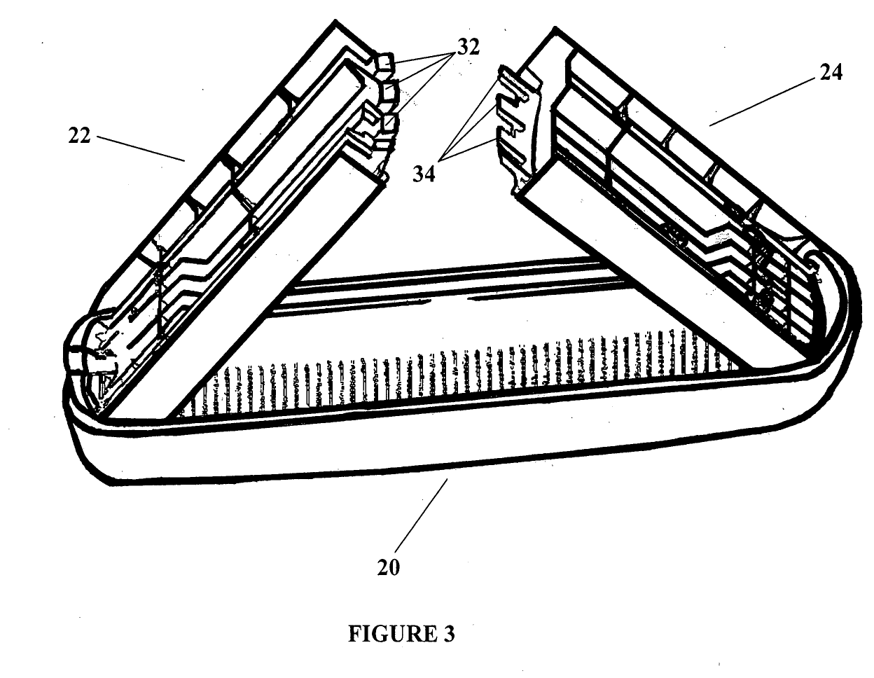

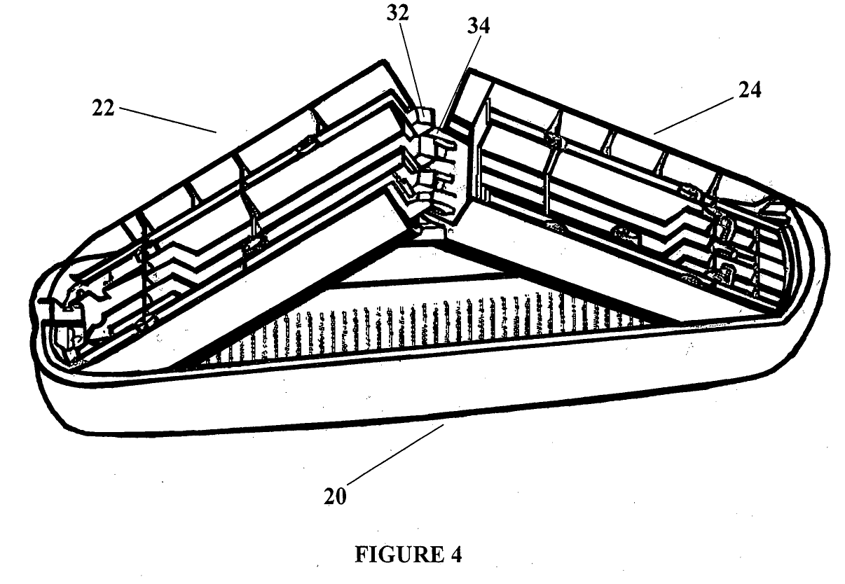

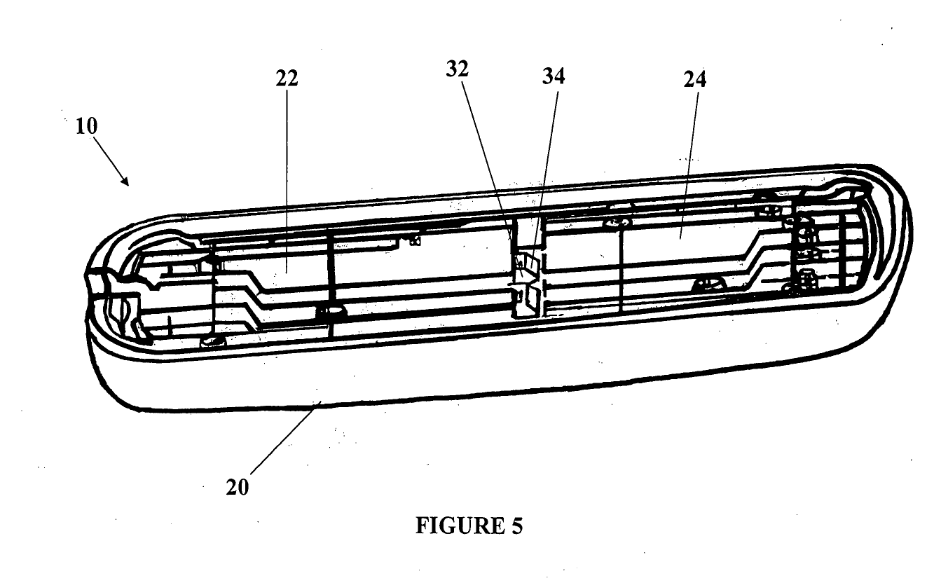

FIGS. 3, 4 and 5 illustrate the steps in attaching soft cover 20 to substrate elements 22 and 24 to form a single piece, which is then attached to base 26 to form the completer armrest 10. As seen in FIG. 3, first substrate element 22 and second substrate element 24 are inserted into soft cover 20 at an angle (i.e. 45 degrees) such that the fingers 32 and 34 are protruding towards each other. The angle of the substrate elements 22 and 24 is then reduced, preferably by applying pressure in the center area between the substrate elements 22 and 24 such that the fingers 32 and 34 engage one another as shown in FIG. 4. The process concludes as shown in FIG. 5, where the angle is then reduced to zero, such that fingers 32 and 34 are fully interlocked, resulting in substrate elements 22 and 24 forming a single piece which is attached to soft cover 20.

For ease of assembly, soft cover 20 may be formed with a lip or protruding edge that engages the end of the inserted substrate element to inhibit slippage or other problems during the assembly process. Likewise, substrate elements 22 and 24 may have lips or protruding edges to similarly engage the ends of soft cover 20 during the assembly process.

The single covered piece thus formed is then attached to base 26, along with any intervening elements such as hinge 28 and clasp 30, to form the desired soft armrest 10.

By forming the internal substrate from two separate elements 22 and 24 and engaging them within the soft cover 20 by the process described herein, a tight fit for the soft cover 20 over the resulting substrate is assured.

As an alternative to the embodiment shown, particularly if the soft armrest 10 is to remain in a fixed position, the substrates 22 and 24 may be sufficient to secure the soft armrest 10 to the floor console 12 once assembled. In such a design, base 26 is not required. Hinge 28 and clasp 30 are also not required if there is no storage beneath soft armrest 10.

Depending on the design of fingers 32 and 34, they made be made severable or partially severable after locking. In this case, once the fingers are interlocked, the severable parts are removed to prevent separation of the substrates 22 and 24 after assembly.

This concludes the description of a presently preferred embodiment of the invention. The foregoing description has been presented for the purpose of illustration and is not intended to be exhaustive or to limit the invention to the precise form disclosed. Many modifications and variations are possible in light of the above teaching and will be apparent to those skilled in the art. It is intended the scope of the invention be limited not by this description but by the claims that follow.

What is claimed is:

1. A process for manufacturing armrests with soft covers, comprising the steps of:
a) providing a soft cover,
b) providing a substrate, said substrate divided into two substrate parts, and
c) attaching said soft cover to said substrate to form an armrest by engaging each of said two substrate parts with opposite ends of said soft cover and manipulating said two substrate parts such that said two substrate parts engage each other to form a unitary substrate securely covered by said soft cover.

2. The process as claimed in claim 1, additionally comprising the step of securing said unitary substrate to a base.

3. The process as claimed in claim 2, wherein, prior to said securing step, a hinge is inserted at one end of said armrest and a clasp is inserted at an opposite end to said one end of said armrest, said hinge and said clasp being secured between said unitary substrate and said base.

4. The process as claimed in claim 1, wherein each of said two substrate parts of said substrate includes a number of flanges at one end, said one end being opposite to said end of said substrate part which engages said soft cover, such that said flanges interlock to form said unitary substrate.

5. The process as claimed in claim 4, additionally comprising the step of severing said flanges after said two substrate parts are engaged to prevent separation of said unitary substrate.

6. The process as claimed in claim 1, wherein said two substrate parts are identical to one another.

7. The process as claimed in claim 1, wherein said two substrate parts are mirror images of one another.

8. The process as claimed in claim 1, wherein said two substrate parts approximate one another.

9. An armrest with a soft cover, produced by engaging each of two substrate parts at opposite ends of said soft cover and manipulating said two substrate parts such that said two substrate parts engage each other to form a unitary substrate securely covered by said soft cover.

10. The armrest as claimed in claim 9, additionally comprising a base attached to said unitary substrate.

11. The armrest as claimed in claim 10, additionally comprising a hinge at one end of said armrest and a clasp at an opposite end to said one end of said armrest.

12. The armrest as claimed in claim 9, wherein each of said two substrate parts includes a number of flanges at one end, said one end being opposite to said end of said substrate part which engages said soft cover, such that said flanges interlock to form said unitary substrate.

13. The armrest as claimed in claim 12, wherein said flanges are severable.

14. The armrest as claimed in claim 9, wherein said two substrate parts are identical to one another.

15. The armrest as claimed in claim 9, wherein said two substrate parts are mirror images of one another.

16. The armrest as claimed in claim 9, wherein said two substrate parts approximate one another.
